(19) United States
(12) Patent Application Publication
(10) Pub. No.: US 2014/0310059 A1
(43) Pub. Date: Oct. 16, 2014

(54) SYSTEM , METHOD AND COMPUTER PROGRAM FORECASTING ENERGY PRICE

(71) Applicant: ENERGENT INCORPORATED, Waterloo (CA)

(72) Inventors: Gordon D. Ellis, Waterloo (CA); Claudio Adrian Canizares, Kitchener (CA); Kankar Bhattacharya, Waterloo (CA); Alfredo Vaccaro, Angri (SA) (IT); Tarek, Hussein Mostafa El-Fouly, Saint-Basile-Le-Grand (CA)

(73) Assignee: ENERGENT INCORPORATION, Waterloo (CA)

(21) Appl. No.: 13/261,873

(22) PCT Filed: Nov. 14, 2012
(86) PCT No.: PCT/CA2012/001056

§ 371 Date: May 14, 2014

Related U.S. Application Data
(60) Provisional application No. 61/559,295, filed on Nov. 14, 2011.

(51) Int. Cl. G06Q 30/02; G06Q 50/06

(52) U.S. Cl. CPC G06Q 30/0206; G06Q 30/0202; G06Q 50/06
USPC 705/7.31

(57) ABSTRACT

A system, method and computer program for forecasting energy price is provided that includes an adaptive hybrid forecasting engine. The adaptive hybrid forecasting engine is operable to generate an energy price forecast based on both a prediction utility and a correction utility. The prediction utility may implement a linear modeling algorithm for predicting energy price based on historical data. The linear modeling algorithm may be a multiplicative seasonal ARIMA (Autoregressive Integrated Moving Average) model, for example, which includes both a regular ARIMA and seasonal ARIMA model. The correction utility may implement an adaptive dynamic correction algorithm that is operable to adapt the energy price forecast based on current or near-current conditions. The adaptive dynamic correction algorithm may be a LL (lazy learning) algorithm.

### FIELD OF THE INVENTION

The present invention relates generally to managing utilization of energy, and more specifically to forecasting a periodic energy price for use by energy market participants.

### BACKGROUND OF THE INVENTION

Forecasting of a periodic energy price, such as an Hourly Energy Price (HEP) (also known as an Hourly Ontario Energy Price (HOEP) in the Province of Ontario, Canada) is crucial for managing utilization of energy in competitive energy markets by market participants—i.e. power generators, power distributors, investors, traders, load serving entities, and the loads themselves. Thus, for example, generation companies can use these energy price forecasts to set up rational offers in the short-term, and price a range of derivative securities for hedging. Energy service entities can use such forecasts to hedge against the risk of price volatility by deciding between serving the load with power from short or long-term contracts or buying it from the spot market. System operators can use it to identify price variations that could affect dispatching of generators and demand on the transmission networks. Large industrial customers could certainly use it for assessing their exposure to market price volatility and managing their risks through long-term, fixed-price contracts, or participation in demand response programs or other programs. Credit rating agencies may use it to monitor the exposure of different players in the market to price fluctuations and risks. Thus, not surprisingly, HEP forecasting has been the focus of several recent studies, and various methods that apply production-cost models or statistical models have been reported in the literature.

Forecasting methods based on production-cost models rely on how systems have operated in the past, incorporating data such as electrical properties of generation units and transmission grids. These methods are based on econometric models to predict how consumers will behave by examining historical relationships and extrapolating them forward. Market operators usually use them to obtain detailed insights into system prices. However, these types of models are complicated to implement and require detailed system operation data such as participants' bidding behavior, generation data, transmission network data, hydrological conditions and fuel prices. To try and overcome these limitations, statistical models may be used to forecast electricity prices from observable trades in the market, since these models require lesser amounts of data compared to production cost models.

Many linear and non linear statistical models have been proposed in the literature to address the HEP forecasting problem. The Autoregressive Integrated Moving Average (ARIMA) model has been one of the most widely used statistical models in HEP forecasting. ARIMA based predictors are straightforward to implement and show good performance especially for short-term HEP forecasting (1-6 hours ahead). These were identified using the known software tools of Scientific Computing Associates Corp. (“SCA”) The performance of these models tend to deteriorate for a 24 hours time forecasting scenario, because the associated HEP series are non-stationary and highly volatile, with non-constant mean and variance and significant outliers. This is due to the complex bidding behavior of market participants that are strongly influenced by a variety of drivers, such as loads, fuel prices, generator operating characteristics and transmission capability, as well as regional and system-wide reliability policies that affect system operation and energy exchange, thereby affecting the bidding dynamics.

Recent research activities in HEP forecasting suggest that non linear learning techniques can be a promising alternative to the traditional ARIMA predictors. Some of the supervised learning systems that have been proposed include: Feed-Forward NN (FFNN), Adaptive Neuro-Fuzzy Inference Systems (NF), Wavelet based approaches, and Recursive NN. In these proposals, ARIMA and supervised learning systems are often compared, with mixed results with respect to HEP forecasting performance.

Therefore, what is needed is a periodic energy price forecasting approach that has improved longer-term forecasting performance.

### SUMMARY OF THE INVENTION

The present invention provides a system, method and computer program for forecasting a periodic (e.g. hourly) energy price by providing an adaptive hybrid forecasting engine. An adaptive hybrid forecasting engine is operable to generate a periodic energy price forecast based on both a prediction routine and correction routine, as described in more detail below. Prediction may be provided by a prediction engine or routine linked to the adaptive hybrid forecasting engine, and correction may be provided by a correction engine or routine linked to the adaptive hybrid forecasting engine.

In an embodiment, the prediction engine may implement a linear modeling algorithm for predicting energy price based on historical data. By way of example, the linear modeling algorithm may be a multiplicative seasonal ARIMA (Autoregressive Integrated Moving Average) model, for example, which includes both a regular ARIMA and seasonal ARIMA model.

In one aspect, there is provided a computer implemented system for managing utilization of energy, the system comprising: a processor; a memory; and an adaptive hybrid forecasting engine, the forecasting engine operable to generate a periodic energy price forecast using a prediction engine and a correction engine for managing utilization of energy, wherein: the prediction engine is configured to generate a set of periodic energy price prediction data based on historical energy price data; and the correction engine is configured to correct the periodic energy price prediction data based on a correction routine utilizing current or near current energy price conditions to generate the periodic energy price forecast.

In another aspect, there is provided a computer implemented method for managing utilization of energy, comprising: operating a prediction engine to generate a set of periodic energy price prediction data based on historical energy price data; and operating a correction engine to correct the periodic energy price prediction data based on a correction routine utilizing current or near current energy price conditions to generate a periodic energy price forecast; whereby, the periodic energy price forecast is used to manage utilization of energy in an energy market.

In another aspect, there is provided a non-transitory computer readable medium storing computer code that when executed on a computing device adapts the device to perform a method for managing utilization of energy, the computer readable medium comprising: code for operating a prediction engine to generate a set of periodic energy price prediction data based on historical energy price data; and code for operating a correction engine to correct the periodic energy price prediction data based on a correction routine utilizing current or near current energy price conditions to generate a periodic energy price forecast; whereby, the periodic energy price forecast is used to manage utilization of energy in an energy market.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### DESCRIPTION OF THE DRAWINGS

FIG. 1 illustrates a system diagram of one implementation of the present invention.

FIG. 2 illustrates a possible implementation of the system of the present invention.

FIGS. 3 and 4 are graphs illustrating the results achievable using the forecasting architecture of the present invention, based on the representative implementation shown in FIG. 2, using either a neural Radial Basis Function Network (RBFN) or an LL-based Corrective Module, compared to the results achievable with the ARIMA model.

FIGS. 5 and 6 are graphs illustrating the real and forecasted HEP for the week corresponding to the worst and the best ARIMA prediction accuracy.

In FIGS. 7 and 8 are graphs illustrating the evolution of the daily mean MAE and the RMSE for the PDP/ARIMA and the LL-based grey-box predictor are illustrated.

FIG. 9 shows a schematic diagram of a generic computing device.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

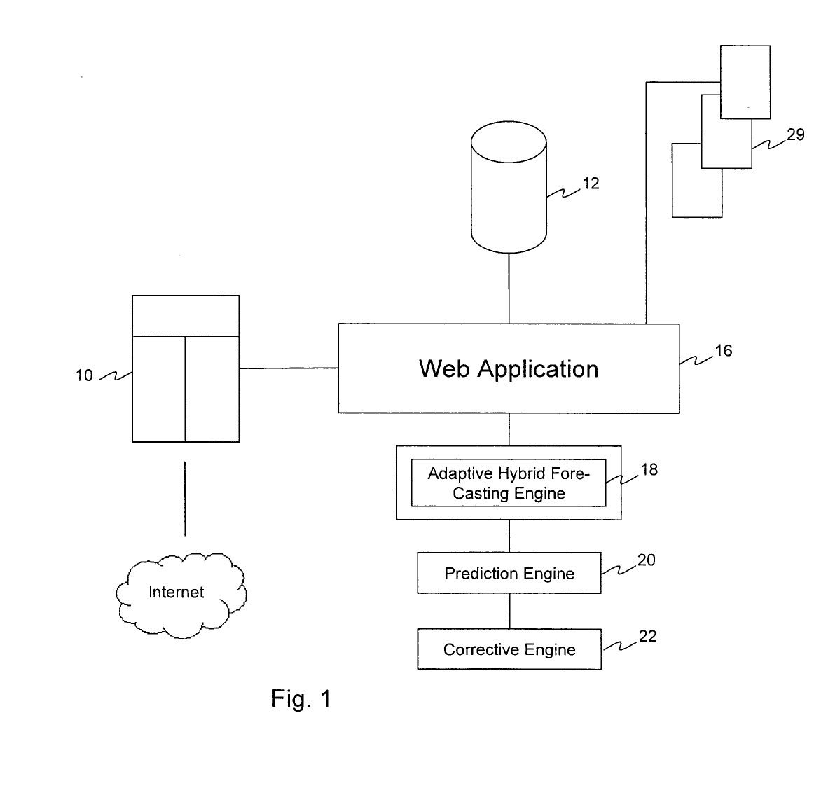

The present invention provides a system, method and computer program for forecasting energy price by providing and utilizing an adaptive hybrid forecasting engine. As illustrated in FIG. 1, the adaptive hybrid forecasting engine is operable to generate an energy price forecast based on both a prediction routine and correction routine as described below. Prediction may be provided by a prediction engine linked to the adaptive hybrid forecasting engine, and correction may be provided by a correction engine linked to the adaptive hybrid forecasting engine. Further details regarding the implementation of the adaptive hybrid forecasting engine are provided below.

The prediction engine may implement a linear modeling algorithm for predicting energy price based on historical data. The linear modeling algorithm may be a multiplicative seasonal ARIMA (Autoregressive Integrated Moving Average) model, for example, which includes both a regular ARIMA and seasonal ARIMA model. While the present invention is explained by referring to the ARIMA model, it should be understood that other forecasting techniques may be used in connection with the present invention, such as other non-hybrid forecasting techniques such as BASE

The correction engine may implement an adaptive dynamic correction algorithm that is operable to adapt the energy price forecast based on current or near-current conditions. The adaptive dynamic correction algorithm may be a LL (lazy learning) algorithm.

FIG. 1 illustrates a system in accordance with the present invention. The system includes an adaptive hybrid forecasting engine that includes a prediction engine (the base forecaster) and a correction engine (implementing the local learning algorithm). The adaptive hybrid forecasting engine may be linked, for example by a network such as the Internet, to an ISO (Independent System Operator) or similar database providing actual energy market information, an ISO forecast database providing ISO energy forecast information and an online database adjournment. In one implementation of the online database adjournment, a historical database is provided for example including a variety of values, which are then used in the LL algorithm and associated processes as explained in detail below (see in particular equation (5) below), and also as per equations (14) and (15) below. It should be understood that in one aspect of the invention, these values are updated continuously as the prediction window moves forward, including as indicated at (14) and (15) below.

It should be understood that the ISO database and the ISO forecast database may be operated by an ISO, or could be cached information obtained from the ISO and stored on computer readable media located proximate the adaptive hybrid forecasting engine, for example. Other configurations, including cloud computing configurations or distributed computing configurations are also contemplated.

The adaptive hybrid forecasting engine provides an output that can be considered to be a function fₖ(·) for each time horizon that can be used to generate an energy price forecasting model.

The general approach to model an input/output phenomenon, in the context of HEP forecasting, with the vector x as input and the scalar y as output, relies on the availability of a collection of observed hourly discrete pairs (x(t),y(t))=(x₁, yₜ), t=1,2, . . . , n (hour), which are typically referred to as a training set. The forecasting problem consists then in predicting the value of the output y(n+1) when the value of the input x(n+1) is known. A suitable function f(·) can be found such that the output variable can be accurately represented by a model in the form:

y(t)=f(x(t))+v(t) (1)

where v(t) represents the modeling error, disturbances and noise. In machine learning, (1) is often referred to as a “supervised learning problem”. If conventional assumptions of normality and whiteness are made on v(t), it follows that a reliable prediction of the output, for a given input, is given by:

ŷ(t)=f(x(t)) (2)

Assuming a linear f(·), (2) can be rewritten as:

ŷ(t)=θ^{T}x(t)+v(t) (3)

where the vector of parameters θ is estimated on the basis of the observed dataset using conventional least-squares techniques. Powerful approximations for non-linear f(·) are possible based on advances in machine learning and data mining.

Formula (1) can be used to represent a variety of prediction problems. In particular, it can be applied to the generic discrete-time NARX (Nonlinear AutoRegressive eXogenous) system identification problem, where the input vector takes the form:

x(t)=[y(t−k), . . . , y(t−k−n+1), u(t−1), . . . , u(t−m)]^{T} (4)

where the constant k≧1 defines the time horizon of the prediction problem, and u(t) denotes an exogenous input/control signal to the dynamical system. The number n of lagged outputs and the number m of lagged control actions are chosen so that these describe accurately the dynamics of the process.

In HEP forecasting problems, the output variable y is the HEP forecasted at t+k, i.e. HEP(t+k), where k is the forecasting horizon, which may for example vary from 1 to 24 hours. The exogenous inputs include the available set of variables influencing the HEP dynamics, which may mainly be the historical and forecasted hourly energy demand profiles, the Pre-Dispatch Price and the predicted Supply Cushion. In this case, the resulting NARX form of the black-box HEP predictor can be stated as follows:

HEP(t+k)=fₖ(HEP(t),HEP(t−1), . . . , HEP(t−n),

E_{L}(t), . . . , E_{L}(t−j),

E_{LF}(t+k−m), . . . , E_{LF}(t+k),

PDP(t+k−h), . . . , PDP(t+k),SC(t+k)) (5)

where E_{L} is the actual energy demand for a jurisdiction, E_{L,f} is the forecasted energy demand, PDP(.) is the pre-dispatch price, and SC(.) is the predicted Supply Cushion. In order to perform the forecasting the model requires the latest n values of HEP, m past and h forecasted demand values. The choice of m, n, h and j values can be obtained using a procedure of cross-validated feature selection performed on the available experimental data. The output of the adaptive hybrid forecasting can used as the function fₖ(.) for each time horizon.

More specifically, the prediction engine provides an energy price forecast for a particular time (t+k) based on historical data obtained from the ISO database. The correction engine provides a more accurate energy price forecast for a particular time (t+k) based on the prediction engine output, historical data obtained from the ISO database, ISO forecast database and the online database adjournment, which itself obtains the prediction engine output.

The prediction engine may implement a multiplicative seasonal ARIMA model that includes both a regular ARMIA(p,d,q) and a seasonal ARIMA (P,D,Q) model, which can be referred to as a seasonal ARIMA(p,d,q)×ARIMA(P,D,Q) model.

The seasonal ARIMA(p,d,q)×ARIMA(P,D,Q) model may be represented by:

φ(B)Φ(B^{s}(1−B^{s})^{d}(1−B)^{D}yₜ=C₀+θ(B)Θ(B^{s})aᵣ t=1, 2, . . . , n (6)

where s is the seasonality (periodicity) of the time series, which may be set to 24; yₜ is the t entry in the time series with n observations; B is the backshift operator (Byₜ=yₜ₋₁); C₀ is a constant term; d and D represent the “trend” order of the regular ARIMA and the seasonal ARIMA models, respectively; aₜ is a sequence of random errors that are independently and identically distributed with a normal distribution N(0,σₐ²); and φ(B) and θ(B) the auto-regressive operator and the moving average operator of the regular ARIMA(p,d,q), respectively, and Φ(B^{s}) and Θ(B^{s}) are the auto-regressive operator and the moving average operator of the seasonal ARIMA(P,D,Q), respectively, which are defined as follows:

φ(B)=(1−φ₁B−φ₂B²− . . . −φₚB^{p}) (7)

θ(B)=(1−θ₁B−θ₂B²− . . . −θ_{q}B^{q}) (8)

Φ(B^{s})=(1−Φ₁B^{s}−Φ₂B^{2s}− . . . −ΦₚB^{Ps}) (9)

Θ(B^{s})=(1−Θ₁B^{s}−Θ₂B^{2s}− . . . −Θ_{Q}B^{Qs}) (10)

where p and q represent the orders of the auto-regressive operator and the moving average operator of the regular ARIMA(p,d,q), respectively, and P and Q represent the orders of the auto-regressive operator and the moving average operator of the regular ARIMA (P,D,Q), respectively.

The seasonal ARIMA (p,d,q)×ARIMA (P,D,Q) model can also be represented mathematically by:

$$\begin{matrix}{( 1 - B )}^{d} {( 1 - {B}^{s} )}^{D} {y}_{t} = C + \frac{θ ( B ) Θ ( {B}^{s} )}{φ ( B ) Φ ( {B}^{s} )} {a}_{t} \\ t = 1 , 2 , … , n \\ where & ( 11 ) \\ C = \frac{{C}_{0}}{( 1 - {φ}_{1} - {φ}_{2} - … - {φ}_{P} ) ( 1 - {Φ}_{1} - {Φ}_{2} - … - {Φ}_{P} )} & ( 12 )\end{matrix}$$

The IARIMA command of the SCA system is used to automatically identify and develop the ARIMA model for the HEP series. It should be understood that the SCA system is operable to initiate a set of instructions, including IARIMA related instructions, to identify the parameters of the ARIMA model. This automatic modeling and identification algorithm is based on the following steps:
1. Determination of the differencing order and number.
2. Generation of a pure non-seasonal and pure seasonal series.
3. Determination of the AR and MA orders.
4. Determination of the constant term.
5. Estimation of the model parameters
6. Model diagnostic check.

If a satisfactory model was not achieved, the IARIMA command will alert the user that the model requires additional investigation. The SCA system will display the last developed model and its residual autocorrelations.

Using the output of the prediction engine, the correction engine provides a more accurate energy price forecast for a particular time (t+k) based on historical data obtained from the ISO database, ISO forecast database and the online database adjournment, which itself obtains the prediction engine output.

The correction engine may implement a lazy learning (LL) algorithm. A lazy learning algorithm provides a plurality of advantages over the prior art, including: (a) a reduced number of assumptions; (b) on-line learning capability; and (c) modeling non-stationarity.

The reduced number of assumptions is a result of LL assuming no a priori knowledge on the process underlying the data. For example, it makes no assumption on the existence of a global function describing the data and no assumptions on the properties of the noise. The only available information is represented by a finite set of input/output observations. This feature is particularly relevant in real datasets where problems of missing features, non-stationarity and measurement errors make it appealing to apply a data-driven and assumption-free approach.

LL also provides on-line learning capability. LL can easily deal with on-line learning tasks where the number of training samples increases with time. In this case, LL simply adds new points to the dataset. Unlike neural networks, LL does not need time-consuming re-training when new data become available.

LL also provides modeling non-stationarity. LL can deal with time-varying configurations where the stochastic process underlying the data is non-stationary. In this case, it is sufficient to interpret the notion of neighborhood not only spatially but both in a spatial and temporal sense. For each query point, the neighbors are no more the samples that have similar inputs but the ones that both have similar inputs and have been collected most recently in time. Therefore, the time variable becomes a further feature considered for accurate forecasting.

The output of the correction engine is the price forecast. The adaptive hybrid forecasting engine addresses this problem for a time horizon which ranges over the interval k ∈ [1,24] by:

HEP(t+k)=fₖ(HEP(t), HEP(t−1), . . . , HEM(t−n)

HEP_{ARIMA}(t+k), . . . , HEP_{ARIMA}(t+k−g),

E _{L}(t), . . . , E_{L}(t−j), E_{LF}(t+k−m), . . . ,

E_{F}(t+k), PDP(t+k−h), . . . , PDP(t+k),

SC(t+k)) (13)

where HEP_{t,ARIMA} (t) is the prediction of HEP(t) returned by the ARIMA model. This input could be the result of any other forecasting process besides ARIMA.

The learning method selection criteria used to address this problem are based on the global versus local, lazy versus eager, and linear versus non-linear dichotomies. The classical linear regression is an example of a global, eager, and linear approach, whereas NNs are classical instances of a global, eager, and nonlinear approach. NNs are global since a single representation covers the whole input space; they are eager since samples used for tuning the network are discarded without waiting for any query; and finally, they are nonlinear since the relation between the weights and the output is nonlinear. The LL method used here is a local, lazy and nonlinear approach, where a dataset of samples is stored, and any processing is deferred until an explicit request for a prediction is received. When this happens, the dataset is searched for samples falling in a neighborhood of the query point. Such samples are used for identifying a local model that is then evaluated in the query point to return a prediction. The local model is then discarded and the procedure is repeated from scratch for subsequent queries.

The major appeal of LL is precisely its divide-and-conquer nature, since LL reduces a complex and nonlinear modelling problem into a sequence of easily manageable local linear problems, one for each query. This allows exploiting, on a local basis, the whole range of linear identification and validation techniques which are fast, reliable, and come with a wealth of theoretical analyses, justifications, and guarantees.

The LL model used in the proposed forecasting architecture is based on a historical data base of input/output observations, contained in the following input matrix and output vector:

$$\begin{matrix}\begin{matrix}{x}^{k} = [ \begin{matrix}\begin{matrix}HEP ( {t}_{1} ) , … , HEP ( {t}_{1} - n ) , {HEP}_{ARIMA} ( {t}_{1} + k ) , … , {HEP}_{ARIMA} \\ ( {t}_{1} + k - g ) , {E}_{L} ( {t}_{1} ) , … {E}_{L} ( {t}_{1} - j ) , {E}_{LF} ( {t}_{1} + k ) , … , {E}_{LF} \\ ( {t}_{1} + k - m ) , PDP ( {t}_{1} + k ) , … , PDP ( {t}_{1} + k - h ) , SC ( {t}_{1} + k )\end{matrix} \\ \begin{matrix}HEP ( {t}_{2} ) , … , HEP ( {t}_{2} - n ) , {HEP}_{ARIMA} ( {t}_{2} + k ) , … , \\ {HEP}_{ARIMA} ( {t}_{2} + k - g ) , {E}_{L} ( {t}_{2} ) , … {E}_{L} ( {t}_{2} - j ) , {E}_{LF} ( {t}_{2} + k ) , … , \\ {E}_{LF} ( {t}_{2} + k - m ) , PDP ( {t}_{2} + k ) , … , PDP ( {t}_{2} + k - h ) , SC ( {t}_{2} + k ) \\ ⋮\end{matrix} \\ \begin{matrix}HEP ( {t}_{M} ) , … , HEP ( {t}_{M} - n ) , {HEP}_{ARIMA} ( {t}_{M} + k ) , … , \\ {HEP}_{ARIMA} ( {t}_{M} + k - g ) , {E}_{L} ( {t}_{M} ) , … {E}_{L} ( {t}_{M} - j ) , \\ {E}_{LF} ( {t}_{M} + k ) , … , {E}_{LF} ( {t}_{M} + k - m ) , PDP ( {t}_{M} + k ) , … , \\ PDP ( {t}_{M} + k - h ) , SC ( {t}_{M} + k )\end{matrix}\end{matrix} ] \\ = [ \begin{matrix}{( {x}_{1}^{k} )}^{T} \\ {( {x}_{2}^{k} )}^{T} \\ ⋮ \\ {( {x}_{M}^{k} )}^{T}\end{matrix} ]\end{matrix} & ( 14 ) \\ {y}^{k} = [ \begin{matrix}HEP ( {t}_{1} + k ) \\ HEP ( {t}_{2} + k ) \\ ⋮ \\ HEP ( {t}_{M} + k )\end{matrix} ] = [ \begin{matrix}{y}_{1}^{k} \\ {y}_{2}^{k} \\ ⋮ \\ {y}_{M}^{k}\end{matrix} ] & ( 15 )\end{matrix}$$

where M is the size of the historical database of input/output observations adopted to perform the prediction; the choice of this value can be made following a procedure of cross-validated feature selections performed on the available experimental data. These matrix and vector are adjourned by the latest available information.

These data bases adopted at time t by the LL algorithm to develop the price forecasting for the time (t+k) based on the following steps:
1. Build the input query vector:

$${x}_{q} = [ HEP ( t ) , … , HEP ( t - n ) , {HEP}_{f , ARIMA} ( t + k ) , … , {HEP}_{f , ARIMA} ( t + k - g ) , {E}_{L} ( t ) , … {E}_{L} ( t - j ) , {E}_{L , f} ( t + k ) , … , {E}_{L , f} ( t + k - m ) , PDP ( t + k ) , … , PDP ( t + k - h ) , SC ( t + k ) ] \qquad ( 16 )$$

2. Calculate the Euclidian distance between the input query vector x_{q} and all the vectors xₗ^{k} stored in the input matrix X^{k}:

d_{iq}=∥xₗ^{k}−x_{q}∥∀i ∈ ]1,M] (17)
3. Associate with each input/output pair stored in the data base (xₗ^{k}, yₗ^{k}) a weight factor wᵢ expressed as:

wᵢ=d_{iq} ∀i ∈ [1,M] (18)
4. Generate the matrix Zₙ=WₙXₙ^{k} and vector vₙ=Wₙyₙ^{k}, where n defines a set of close neighbors of x_{q}, as per the recursive procedure explained in detail below, and Wₙ is a diagonal matrix with diagonal elements wₙ_{ₙ}=wᵢ∀i ∈ [nₘᵢₙ, n].

Solve recursively the following linear problem for βₙ:

(Zₙ^{T}Zₙ)βₙ=Zₙ^{T}vₙ (19)
This is known as a locally weighted regression problem, where βₙ is the vector describing the first order polynomial used as local approximator.
6. Calculate the prediction at the query point x_{q} as follows:

ŷ_{q}=x_{q}^{T}βₗ (20)
where l is the “optimal” number of neighbors of x_{q} chosen through the local regression fit and parameter tuning procedure explained next.

The number l is obtained basically solving (19) recursively, starting from a minimum number nₘᵢₙ of neighbors and then adding neighbors until the predicted performance of the corresponding local approximation decays significantly or a maximum number nₘₐₓ of samples is reached. This technique yields the parameters of the model fitted to the n+1 nearest neighbors of x_{q}, and is based on updating the parameters of the model by solving recursively the following equations:

$$\begin{matrix}{P}_{n + 1} = {P}_{n} - \frac{1}{1 + {( {x}_{n + 1}^{k} )}^{T} {P}_{n} {x}_{n + 1}^{k}} {P}_{n} {{x}_{n + 1}^{k} ( {x}_{n + 1}^{k} )}^{T} {P}_{n} & ( 21 ) \\ {γ}_{n + 1} = {P}_{n + 1} {x}_{n + 1}^{k} & ( 22 ) \\ {e}_{n + 1} = {y}_{n + 1}^{k} - {( {x}_{n + 1}^{k} )}^{T} {β}_{n} & ( 23 ) \\ {β}_{n + 1} = {β}_{n} + {γ}_{n + 1} {e}_{n + 1} & ( 24 )\end{matrix}$$

where (xₙ₊₁^{k}, yₙ₊₁^{k}) is the n+1^{th} nearest neighbor of the query point x_{q}; Pₙ is the recursive approximation of the matrix (Zₙ^{T}Zₙ)⁻¹; starting with Pₙ_{ₘᵢₙ}=(Zₙ_{ₘᵢₙ}^{T})⁻¹; and βₙ denotes the optimal least squares parameters of the model fitted to the n nearest neighbor, starting with βₙ_{ₘᵢₙ}=(Zₙ^{T}Zₙ)⁻¹zₙ_{ₘᵢₙ}^{T}vₙ_{ₘᵢₙ}.

After calculating Pₙ₊₁, the i^{th} leave-one-out error, which is defined as the difference between the stored output yᵢ^{k} and the prediction given by the local linear model βₙ₊₁ centered in x_{q} and fitted using the [nₘᵢₙ,n] nearest neighbors available but the i^{th}, is calculated for each i ∈ [nₘᵢₙ,n] as follows:

$${e}_{n + 1}^{cv} ( i ) = \frac{{y}_{i}^{k} - {( {x}_{i}^{k} )}^{T} {β}_{n + 1}}{1 + {( {x}_{i}^{k} )}^{T} {P}_{n + 1} {x}_{i}^{k}} \qquad ( 25 )$$

Starting from these values, the “quality” of the identified models is assessed at each iteration using a reliable estimation of the prediction error in x_{q} based on a leave-one-out cross validation procedure that relies on the PRESS statistic. This cross validation is performed here using the local version of the PRESS statistic as follows:

$${MSE}_{n}^{cv} ( {x}_{q} ) = \frac{1}{{\sum }_{i = {n}_{min}}^{n} {w}_{i}^{2}} {\sum }_{i = {n}_{min}}^{n} {[ {w}_{i} {e}_{n}^{cv} ( i ) ]}^{2} \qquad ( 26 )$$

The final prediction of the value of the regression function, i.e. (20), can thus be obtained using the winner-takes-all paradigm in which the model associated with the smaller estimated prediction error is chosen as follows:

$$l = arg {min}_{n} {MSE}_{n}^{cv} ( {x}_{q} ) \qquad ( 27 )$$

For example, verification was conducted on the adaptive hybrid forecasting engine for 24 hour ahead HEP forecasting for the Ontario market, i.e. the HOPE (Hourly Ontario Energy Price for k=24. The associated results presented and described are based on the full one-year HOEP and the Hourly Energy Demand profiles recorded during 2007. The PDPs and predicted Supply Cushion profiles are not considered in this experiment since they were not available for this period. Forecasting accuracy was evaluated based on the Root Mean Square Error (RMSE), the Mean Absolute Error (MAE) and the Mean Absolute Percentage Error (MAPE), which are defined as follows:

$$RMSE = \sqrt{\frac{{\sum }_{t = 1}^{N} {( HOEP ( i ) - {HOEP}_{f} ( i ) )}^{2}}{N}}$$

$$MAE = \frac{{\sum }_{t = 1}^{N} \vert HOEP ( i ) - {HOEP}_{f} ( i ) \vert}{N}$$

$$MAPE = \frac{{\sum }_{r = 1}^{N} \frac{\vert HOEP ( i ) - {HOEP}_{f} ( i ) \vert}{\vert HOEP ( i ) \vert}}{N}$$

where N is the number of forecasted HOPE values.

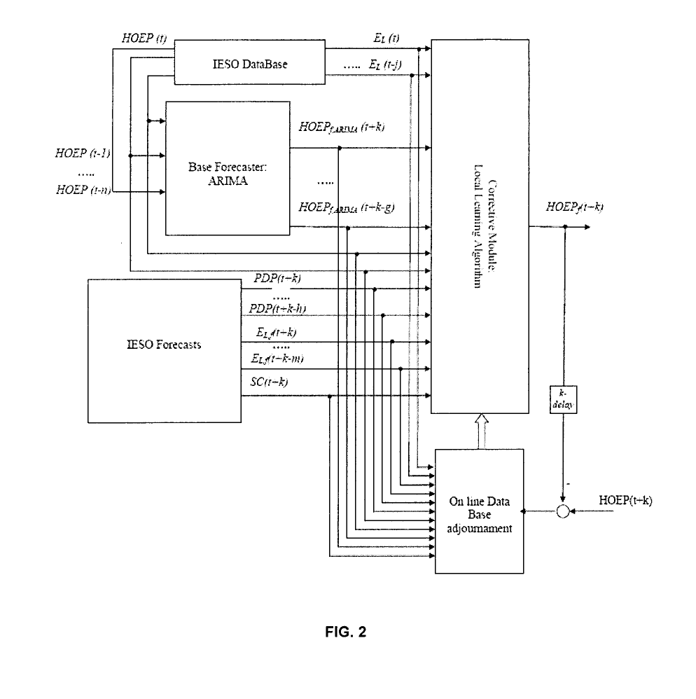

FIG. 2 illustrates a hybrid architecture for implementing the present invention. In particular, this architecture diagram illustrates the combination of a known forecaster with a corrective module to provide the novel system and architecture of the present invention.

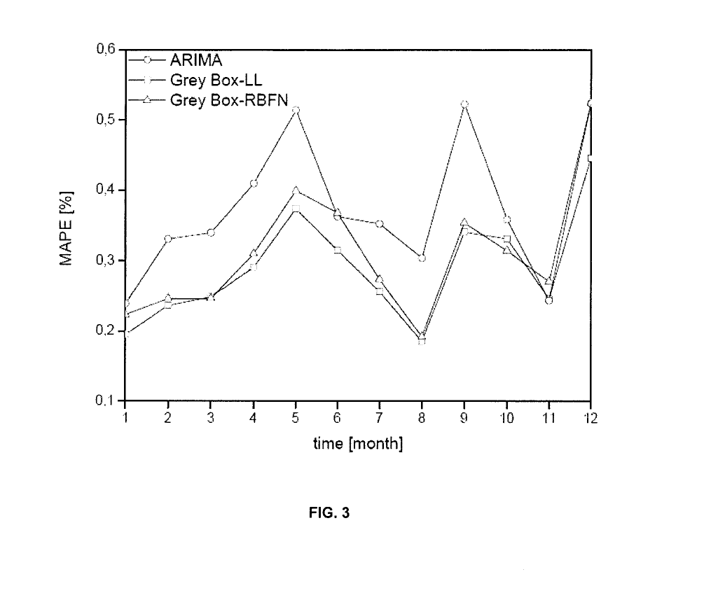

The results shown in FIG. 3 were obtained by applying the proposed forecasting architecture using either a neural Radial Basis Function Network (RBFN) or an LL-based Corrective Module in the hybrid architecture depicted in FIG. 2, and compared with those obtained with the ARIMA model. Moreover, in order to assess the benefits of the proposed architecture compared to a classic black-box forecasting approach, the forecasting results of an FFNN-based HOEP predictor were also used. The FFNN was obtained by training a multi-layer perceptron with a single hidden layer and 5 sigmoidal neurons by means of a Scaled Conjugate Gradient algorithm, considering 500 epochs and assuming a goal Mean Square Error (MSE) of 10³. An adaptation mechanism was used in both the grey- and the black-box models to sequentially update the knowledge base with new samples when the forecasting error is detected to be worse than a fixed threshold.

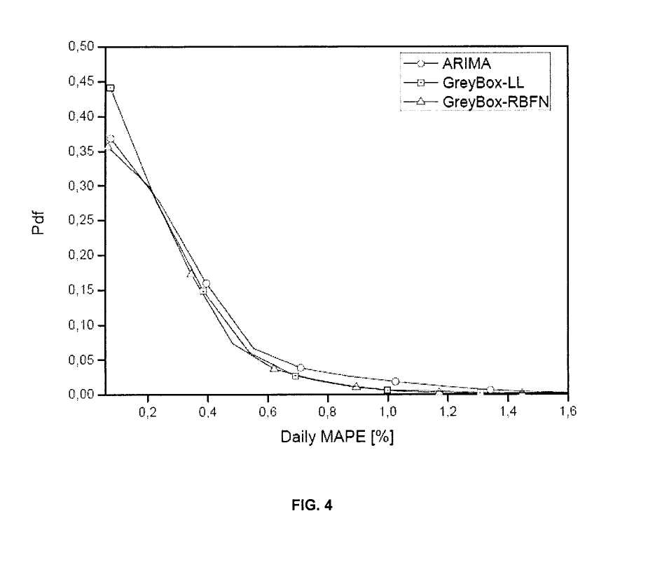

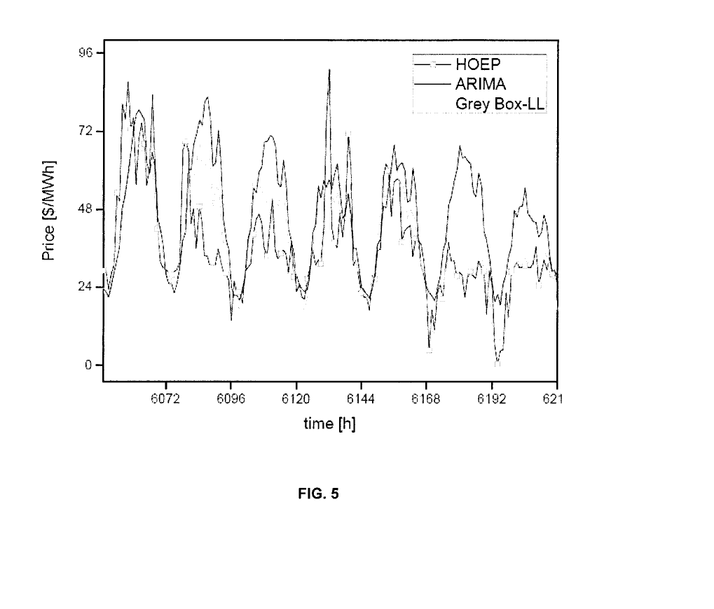

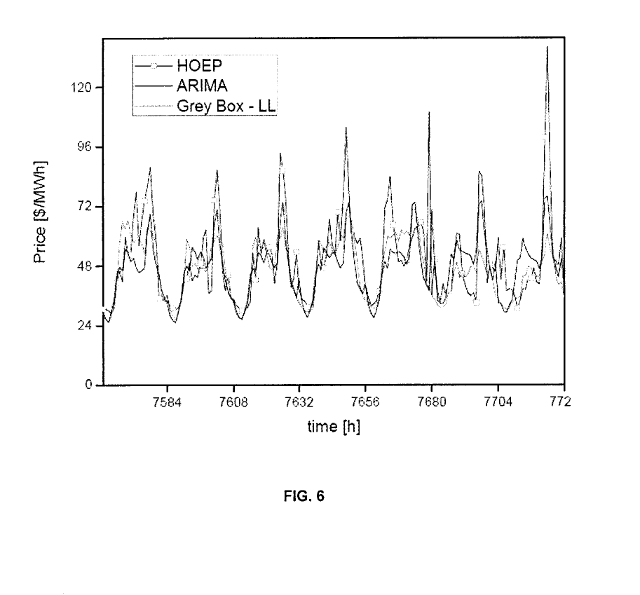

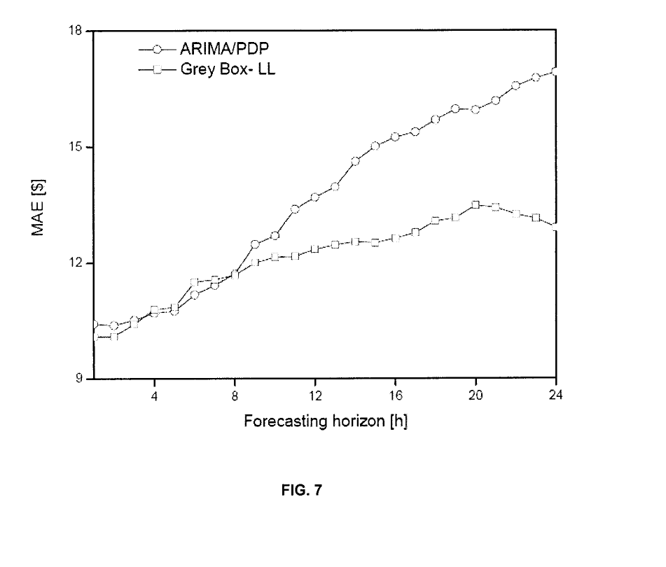

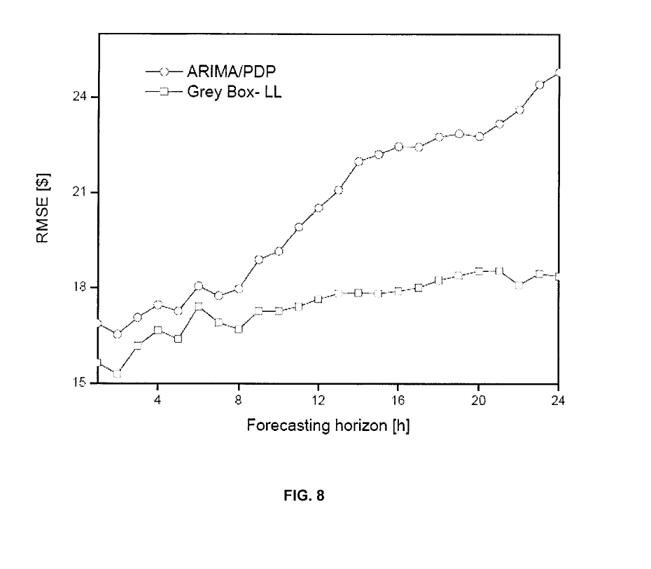

The results obtained for the different forecasting models show that the adaptive hybrid forecasting engine, for both the RBFN and LL modules, outperforms the ARIMA and the FFNN models, as expected. These results are shown in Table 1 (reproduced below). FIGS. 3 and 4 show the evolution and the statistical characterization of the MAPE monthly mean obtained by the ARIMA and the grey-box predictor, based on both RBFN and LL; these profiles illustrate how the grey-box forecasting approach refines the predictions obtained from the ARIMA model. FIGS. 5 and 6 illustrate the real and forecasted HEP for the week corresponding to the worst and the best ARIMA prediction accuracy, and the corresponding errors are shown in Table 2 (reproduced below); observe that, in both cases, the grey-box corrector forecasting errors are clearly smaller than the ARIMA ones.

TABLE I
DAILY FORECASTING ERRORS

| | ARIMA | | | FFFN | | |
|---|---|---|---|---|---|---|
| Error | Min. | Aver. | Max | Min | Aver. | Max |
| MAE [$] | 5.46 | 13.83 | 23.59 | 6.10 | 13.38 | 20.90 |
| MAPE [%] | 17.28 | 36.17 | 80.80 | 17.23 | 33.87 | 73.76 |
| RMSE [$] | 7.69 | 18.86 | 38.36 | 8.43 | 18.62 | 38.88 |

Grey-Box

| | LL | | | RBFN | | |
|---|---|---|---|---|---|---|
| Error | Min. | Aver. | Max | Min | Aver. | Max |
| MAE [$] | 4.91 | 11.28 | 20.34 | 6.12 | 11.55 | 19.32 |
| MAPE [%] | 14.03 | 27.76 | 56.95 | 16.37 | 29.33 | 59.57 |
| RMSE [$] | 6.58 | 16.19 | 35.08 | 7.52 | 16.09 | 35.40 |

TABLE II
ERRORS FOR BEST AND WORST FORECASTED WEEKS

| | Grey Box - LL | | | ARIMA | | |
|---|---|---|---|---|---|---|
| Error | Min. | Aver. | Max | Min. | Aver. | Max |

Worst ARIMA Week

| | | | | | | |
|---|---|---|---|---|---|---|
| MAE [$] | 0.06 | 8.4 | 37.21 | 0.04 | 14.01 | 48.77 |
| MAPE [%] | 0 | 35 | 166.6 | 0 | 80 | 550.3 |

Best ARIMA week

| | | | | | | |
|---|---|---|---|---|---|---|
| MAE [$] | 0 | 9.16 | 75.20 | 0 | 9.39 | 72.05 |
| MAPE [%] | 0 | 15.6 | 64 | 0 | 17.3 | 95 |

Another verification example analyzes the performances of the proposed hybrid architecture for 1 to 24 hour ahead HOEP forecasting, i.e. the forecasting horizon k in this case varies in the range [1,24]. The associated results presented and described are based on the HOEP and PDP profiles recorded from August to November 2008. Since the PDPs were missing in some days, the corresponding ARIMA predictions were used in that case for comparison purposes. The Supply Cushion was used in this case.

In FIGS. 7 and 8, the evolution of the daily mean MAE and the RMSE for the PDP/ARIMA and the LL-based grey-box predictor are illustrated. These profiles clearly illustrate the better forecasting accuracy of the grey-box forecast model for all hours, but especially for the afternoon hours.

Implementation

The present invention may be implemented in a number of ways including as a network-implemented server program, a computer program linked to a standalone computer, or may be integrated into or embedded in a third party software program.

The system of the present invention is best understood as a computer device that includes or obtains the computer instructions of the aforesaid computer program. The computer program may consist of one or more computer software components that implement the energy forecasting method described herein.

For example, referring to FIG. 1, the system may include a web server 10, which is linked to a database 12. The database may include historical data used by the energy forecasting method described. The web server 10 is linked to a web application 16 which is linked to or includes the adaptive hybrid forecasting engine 18 of the present invention. The web application 16 may be operable to present one or more interfaces that enable a user to assemble the parameters of an energy forecast query, or these queries may based on predetermined parameters generate energy forecasts on an automated basis, and make the resulting forecast information available to one or more authorized users or computers. The adaptive hybrid forecasting engine 18 is operable to pull information from the database. This information may include information associated with a particular user or company, may include historical information for the company or the applicable utility for example. In addition, the web application 16 may be operable to pull information from external sources and populate the database 12 in order to provide the data for processing by operation of the adaptive hybrid forecasting engine 18. The web application 16 may include or be linked to a web crawler that is operable to obtain such information.

The adaptive hybrid forecasting engine 18 may also include or be linked to a prediction engine 20 and a correction engine 22 as described above. The web application 16 includes or is linked to programming for using the output of the adaptive hybrid forecasting engine to generate energy pricing forecast information as output 24 to the user or company, and possibly process such information to generate one or more reports for example using one or more reporting tools and a presentment tool (not shown). The system may be extended in a number of ways obvious to those skilled in the art, such as linking to or including in the web application 16 an analytics engine that is operable to further enhance the energy pricing forecast information for example to building energy savings models to generate energy savings suggestions based on operational data.

The present system and method should not be considered to be limited to the particular computer system or computer program implementation. For example, the present system and method may be implemented using a distributed and networked computing environment comprising at least one computing device.

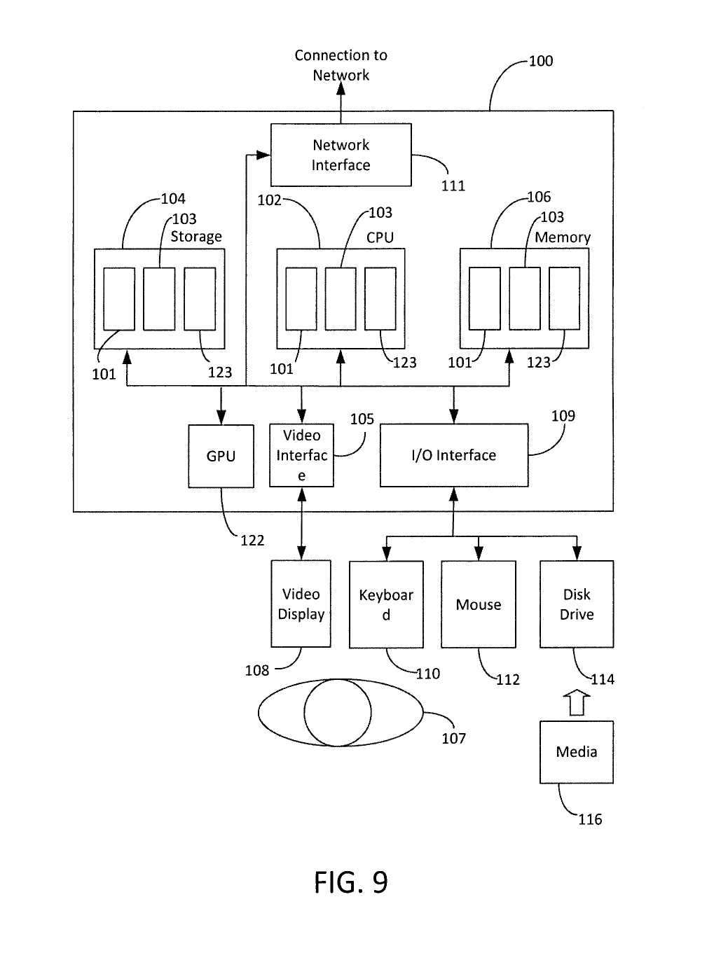

The present system and method may be practiced in various embodiments. A suitably configured computer device, and associated communications networks, devices, software and firmware may provide a platform for enabling one or more embodiments as described above. By way of example, as shown in FIG. 9, a generic computer device 100 may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present system and method may be practiced on virtually any manner of computer device including a desktop computer, laptop computer, tablet computer, provided that optimal processing, memory and other hardware/software requirements are met. The present system and method may also be implemented as a computer-readable/useable medium that includes computer program code to enable one or more computer devices to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

Thus, in an aspect, there is provided a computer implemented system for managing utilization of energy, the system comprising: a processor; a memory; and an adaptive hybrid forecasting engine, the forecasting engine operable to generate a periodic energy price forecast using a prediction engine and a correction engine for managing utilization of energy, wherein: the prediction engine is configured to generate a set of periodic energy price prediction data based on historical energy price data; and the correction engine is configured to correct the periodic energy price prediction data based on a correction routine utilizing current or near current energy price conditions to generate the periodic energy price forecast.

I an embodiment, the prediction engine is adapted to execute a prediction model based on the historical energy price data.

In another embodiment, the prediction model is a linear model, such as an autoregressive integrated moving average (ARIMA) model.

In another embodiment, the correction engine is adapted to correct the periodic energy price prediction data utilizing current or near-current conditions based on a local, lazy, non-linear learning model.

In another embodiment, the correction engine is further adapted to obtain the periodic energy price forecast by: (i) storing a dataset of samples; (ii) upon receiving a request for a periodic energy price forecast, selecting samples from the dataset of samples which are the nearest neighbours to a given query point; and (iii) utilizing the selected samples to identify a local model for evaluating the query point to return the periodic energy price forecast.

In another embodiment, the correction engine is further adapted to provide a periodic energy price forecast over different time periods.

In another embodiment, the time periods include hourly, daily, or weekly energy price forecasts.

In another aspect, there is provided a computer implemented method for managing utilization of energy, comprising: operating a prediction engine to generate a set of periodic energy price prediction data based on historical energy price data; and operating a correction engine to correct the periodic energy price prediction data based on a correction routine utilizing current or near current energy price conditions to generate a periodic energy price forecast; whereby, the periodic energy price forecast is used to manage utilization of energy in an energy market.

In an embodiment, the method further comprises operating the prediction engine to execute a prediction model based on the historical energy price data.

In another embodiment, prediction model is a linear model, such as an autoregressive integrated moving average (ARIMA) model.

In another embodiment, the method further comprises operating the correction engine to correct the periodic energy price prediction data utilizing current or near-current conditions based on a local, lazy, non-linear learning model.

In another embodiment, the method further comprises operating the correction engine to obtain the periodic energy price forecast by: (i) storing a dataset of samples; (ii) upon receiving a request for a periodic energy price forecast, selecting samples from the dataset of samples which are the nearest neighbours to a given query point; and (iii) utilizing the selected samples to identify a local model for evaluating the query point to return the periodic energy price forecast.

In another embodiment, the correction engine is further adapted to provide a periodic energy price forecast over different time periods.

In another embodiment, the time periods include hourly, daily, or weekly energy price forecasts.

In another aspect, there is provided a non-transitory computer readable medium storing computer code that when executed on a computing device adapts the device to perform a method for managing utilization of energy, the computer readable medium comprising: code for operating a prediction engine to generate a set of periodic energy price prediction data based on historical energy price data; and code for operating a correction engine to correct the periodic energy price prediction data based on a correction routine utilizing current or near current energy price conditions to generate a periodic energy price forecast; whereby, the periodic energy price forecast is used to manage utilization of energy in an energy market.

In an embodiment, the non-transitory computer readable medium further comprises code for operating the prediction engine to execute a prediction model based on the historical energy price data.

In an embodiment, the prediction model is a linear model, such as an autoregressive integrated moving average (ARIMA) model.

In an embodiment, the non-transitory computer readable medium further comprises code for operating the correction engine to correct the periodic energy price prediction data utilizing current or near-current conditions based on a local, lazy, non-linear learning model.

In an embodiment, the non-transitory computer readable medium further comprises code for operating the correction engine to obtain the periodic energy price forecast by: (i) storing a dataset of samples; (ii) upon receiving a request for a periodic energy price forecast, selecting samples from the dataset of samples which are the nearest neighbours to a given query point; and (iii) utilizing the selected samples to identify a local model for evaluating the query point to return the periodic energy price forecast.

In an embodiment, the non-transitory computer readable medium further comprises to operate the correction engine to provide a periodic energy price forecast over different time periods.

In an embodiment, the time periods include hourly, daily, or weekly energy price forecasts.

While various embodiments and illustrative examples have been described above, it will be appreciated that these embodiments and illustrative examples are not limiting, and the scope of the invention is defined by the following claims.

1. A computer implemented system for managing utilization of energy, the system comprising:
a processor;
a memory; and
an adaptive hybrid forecasting engine, the forecasting engine operable to generate a periodic energy price forecast using a prediction engine and a correction engine for managing utilization of energy, wherein:
the prediction engine is configured to generate a set of periodic energy price prediction data based on historical energy price data; and
the correction engine is configured to correct the periodic energy price prediction data based on a correction routine utilizing current or near current energy price conditions to generate the periodic energy price forecast.

2. The computer implemented system of claim 1, wherein the prediction engine is adapted to execute a prediction model based on the historical energy price data.

3. The computer implemented system of claim 2, wherein the prediction model is a linear model.

4. The computer implemented system of claim 2 or 3, wherein the correction engine is adapted to correct the periodic energy price prediction data utilizing current or near-current conditions based on a local, lazy, non-linear learning model.

5. The computer implemented system of claim 4, wherein the correction engine is further adapted to obtain the periodic energy price forecast by:
(i) storing a dataset of samples;
(ii) upon receiving a request for a periodic energy price forecast, selecting samples from the dataset of samples which are the nearest neighbours to a given query point; and
(iii) utilizing the selected samples to identify a local model for evaluating the query point to return the periodic energy price forecast.

6. The computer implemented system of claim 5, wherein the correction engine is further adapted to provide a periodic energy price forecast over different time periods.

7. The computer implemented system of claim 6, wherein the time periods include hourly, daily, or weekly energy price forecasts.

8. A computer implemented method for managing utilization of energy, comprising:
operating a prediction engine to generate a set of periodic energy price prediction data based on historical energy price data; and
operating a correction engine to correct the periodic energy price prediction data based on a correction routine utilizing current or near current energy price conditions to generate a periodic energy price forecast;
whereby, the periodic energy price forecast is used to manage utilization of energy in an energy market.

9. The computer implemented method of claim 8, further comprising operating the prediction engine to execute a prediction model based on the historical energy price data.

10. The computer implemented method of claim 9, wherein the prediction model is linear model.

11. The computer implemented method of claim 9 or 10, further comprising operating the correction engine to correct the periodic energy price prediction data utilizing current or near-current conditions based on a local, lazy, non-linear learning model.

12. The computer implemented method of claim 11, further comprising operating the correction engine to obtain the periodic energy price forecast by:
(i) storing a dataset of samples;
(ii) upon receiving a request for a periodic energy price forecast, selecting samples from the dataset of samples which are the nearest neighbours to a given query point; and
(iii) utilizing the selected samples to identify a local model for evaluating the query point to return the periodic energy price forecast.

13. The computer implemented method of claim 12, wherein the correction engine is further adapted to provide a periodic energy price forecast over different time periods.

14. The computer implemented method of claim 13, wherein the time periods include hourly, daily, or weekly energy price forecasts.

15. A non-transitory computer readable medium storing computer code that when executed on a computing device adapts the device to perform a method for managing utilization of energy, the computer readable medium comprising:
code for operating a prediction engine to generate a set of periodic energy price prediction data based on historical energy price data; and
code for operating a correction engine to correct the periodic energy price prediction data based on a correction routine utilizing current or near current energy price conditions to generate a periodic energy price forecast;
whereby, the periodic energy price forecast is used to manage utilization of energy in an energy market.

16. The non-transitory computer readable medium of claim 15, further comprising code for operating the prediction engine to execute a prediction model based on the historical energy price data.

17. The non-transitory computer readable medium of claim 16, wherein the prediction model is a linear model.

18. The non-transitory computer readable medium of claim 16 or 17, further comprising code for operating the correction engine to correct the periodic energy price prediction data utilizing current or near-current conditions based on a local, lazy, non-linear learning model.

19. The non-transitory computer readable medium of claim 18, further comprising code for operating the correction engine to obtain the periodic energy price forecast by:
(i) storing a dataset of samples;
(ii) upon receiving a request for a periodic energy price forecast, selecting samples from the dataset of samples which are the nearest neighbours to a given query point; and
(iii) utilizing the selected samples to identify a local model for evaluating the query point to return the periodic energy price forecast.

20. The non-transitory computer readable medium of claim 19, further comprising code to operate the correction engine to provide a periodic energy price forecast over different time periods.

21. The non-transitory computer readable medium of claim 20, wherein the time periods include hourly, daily, or weekly energy price forecasts.
